(19) United States
(12) Patent Application Publication
(10) Pub. No.: US 2014/0055215 A1
(43) Pub. Date: Feb. 27, 2014

(54) DISTRIBUTED ELEMENT FILTERS FOR ULTRA-BROADBAND COMMUNICATIONS

(71) Applicants: John E. Rogers, Vero Beach, FL (US); Michael R. Weatherspoon, West Melbourne, FL (US); David M. Smith, Sebastian, FL (US)

(72) Inventors: John E. Rogers, Vero Beach, FL (US); Michael R. Weatherspoon, West Melbourne, FL (US); David M. Smith, Sebastian, FL (US)

(73) Assignee: HARRIS CORPORATION, Melbourne, FL (US)

(21) Appl. No.: 13/592,506

(22) Filed: Aug. 23, 2012

(51) Int. Cl. H01P 1/202; B05D 5/12

(52) U.S. Cl. 333/206; 427/58

(57) ABSTRACT

A method for constructing a radio frequency filter (100) includes depositing on a dielectric substrate (102) a plurality of layers of a conductive material (210, 216, 218, 220, 222), a dielectric material (217), and a sacrificial material (1200, 1500, 1700, 1900). The deposition is controlled to form at least one transmission line (104, 106, 108) including a shield (202) and a center conductor (204) disposed coaxially within the shield. The deposition is further controlled to form at least one distributed filter element electrically coupled to the center conductor (204), and at least one housing (402) electrically coupled to the shield. The method also includes dissolving at least one layer of the sacrificial material to form an interior channel (226) within at least one shield. The dissolving of the sacrificial material also results in the formation of a interior space within at least one housing containing the distributed filter element.

### BACKGROUND OF THE INVENTION

1. Statement of the Technical Field

The inventive arrangements relate to filters for radio frequency signals, and more particularly to low loss filters formed of distributed filter elements.

2. Description of the Related Art

Communication systems, such as broadband satellite communications, commonly operate at extremely high frequencies. For example, communication systems operating at frequencies as high as 300 GHz are known. Filters are a necessary element in all communications system for passing desired signals and blocking other signals, e.g. noise. However, existing filters for high frequencies (e.g. 10 GHz to 300 GHz) are known to suffer from certain limitations. Conventional waveguide based filters for such frequencies have low insertion loss, but are very large in size (on the order of several inches in each dimension). Conversely, ceramic thin-film based filters can be relatively small in size but have low power handling capability. A further drawback of thin film ceramic filters operable at these frequency ranges is that they typically have a relatively large insertion loss.

Three-dimensional microstructures can be formed by utilizing sequential build processes. For example, U.S. Pat. Nos. 7,012,489 and 7,898,356 describe methods for fabricating coaxial waveguide microstructures. These processes provide an alternative to traditional thin film technology, but also present new design challenges pertaining to their effective utilization for advantageous implementation of various RF devices.

### SUMMARY OF THE INVENTION

Embodiments of the invention concern a method for constructing a radio frequency filter. The method includes steps involving depositing on a surface of a dielectric substrate a plurality of layers including at least one layer each of a conductive material, a dielectric material, and a sacrificial material. A deposition of the at least one layer of conductive material is controlled to form at least one transmission line including a shield and a center conductor disposed coaxially within the shield. The deposition of the conductive material is further controlled to form at least one distributed filter element electrically coupled to the center conductor, and at least one housing electrically coupled to the shield. The housing includes walls enclosing at least one distributed filter element. The method also includes dissolving at least one layer of the sacrificial material to form a channel disposed within at least one shield. The channel thus created results in the formation of a first clearance space between the center conductor and each of one or more shield walls, such that the center conductor resides in the channel spaced apart from the shield walls. The dissolving of the sacrificial material also results in the formation of a interior space disposed within at least one housing. The interior space includes a second gap or clearance space between at least one distributed filter element and each of the housing walls, such that at least one distributed filter element resides within the interior space, and is separated from the housing walls by a gap.

The invention also includes a radio frequency filter assembly. The filter assembly includes a dielectric substrate and a plurality of layers of a material arranged in a stack. The layers include a plurality of conductive material layers which are arranged to form at least one transmission line including a shield and a center conductor disposed coaxially within the shield. The conductive material layers also form at least one distributed filter element electrically coupled to the center conductor, and at least one housing electrically coupled to the shield. The housing is comprised of walls which enclose at least one distributed filter element. At least one layer of the dielectric material is arranged to form a first set of two or more tabs extending from at least one the shield wall to the center conductor at spaced intervals along an elongated length of the center conductor. One or more layers of the sacrificial material fills a channel defined by at least one shield, and a first clearance space between the center conductor and each of one or more shield walls. The sacrificial material also fills an interior space defined by at least one housing, including a second clearance space between at least one distributed filter element and each of the plurality of housing walls, such that at least one distributed filter element resides in the interior space separated from the housing walls by a gap. The sacrificial material is configured to support the center conductor and the distributed filter element during a manufacturing process which includes the formation of the tabs. The sacrificial material is one which is selectively dissolvable after the manufacturing process is complete without causing damaging or degrading the structures formed by the conductive material and the dielectric material.

### BRIEF DESCRIPTION OF THE DRAWINGS

Embodiments will be described with reference to the following drawing figures, in which like numerals represent like items throughout the figures, and in which:

FIG. 1 is a perspective view showing a stub filter, with portions of a housing and a shield cut away, that is useful for understanding the inventive arrangements.

FIG. 2 is a cross-sectional view taken along line 2-2 in FIG. 1.

FIG. 3 is a cross-sectional view taken along line 3-3 in FIG. 2.

FIG. 4 is a cross-sectional view taken along line 4-4 in FIG. 1.

FIG. 5 is a cross-sectional view taken along line 5-5 in FIG. 4.

FIG. 6 is a perspective view of a combline filter, with a portion of a housing and a shield cut away, that is useful for understanding the inventive arrangements.

FIG. 7 is a cross-sectional view taken along line 7-7 in FIG. 6.

FIG. 8 is a perspective view of an edge coupled filter, with a portion of a housing and a shield cut away, that is useful for understanding the inventive arrangements.

FIG. 9 is an enlarged perspective view of a housing of the edge coupled filter in FIG. 8 with portions cut away along line 9-9 to reveal an interior.

FIG. 10 is a cross-sectional view taken along line 10-10 in FIG. 8.

FIGS. 11A-21B are a series of drawings which show the stub filter in FIGS. 1-5 in various stages of construction.

### DETAILED DESCRIPTION

The invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The invention is not limited by the illustrated ordering of acts or events, as some acts may occur in different orders and/or concurrently with other acts or events. Furthermore, not all illustrated acts or events are required to implement a methodology in accordance with the invention.

When the dimensions of a circuit are on the order of a wavelength at the intended operating frequency of the device, a distributed element model is used in place of the lumped element model. In the distributed element model, the capacitive, inductive and resistive elements (if any) are not localized or lumped together within discrete components. Instead, these attributes are distributed continuously throughout the material of the circuit. In the distributed element model, each circuit element is treated as being infinitesimally small, and the wires connecting elements are treated as transmission lines having some impedance value.

The present invention concerns distributed element filters for RF signals, and more particularly distributed element filters designed to work at frequencies greater than about 1 GHz. Distributed element filters include various well known filter types including the stub filter, the combline filter, and the edge coupled filter. These types of filters are commonly constructed of elements formed in stripline or microstrip. Depending on the filter type, the distributed filter elements can comprise various different structures which include transmission line stubs, interconnecting segments of transmission lines, and capacitive coupling elements in the form of gaps between adjacent portions of transmission lines. The present invention concerns methods for constructing these and other types of distributed element filters. The resulting filters are physically small in size, have high power handling capability, good linearity, and low loss.

For convenience, the inventive arrangements shall be described herein with respect to a stub filter, a combline filter and an edge coupled filter. However, it should be understood that the invention is not intended to be limited to these particular types of distributed element filters. Instead, the inventive concepts can be extended to many different distributed filters and the embodiments described herein are merely intended as an aid to understanding the invention. The structure of each of the embodiment filters shall be described first, followed by a generalized description of a method for fabricating distributed element filters.

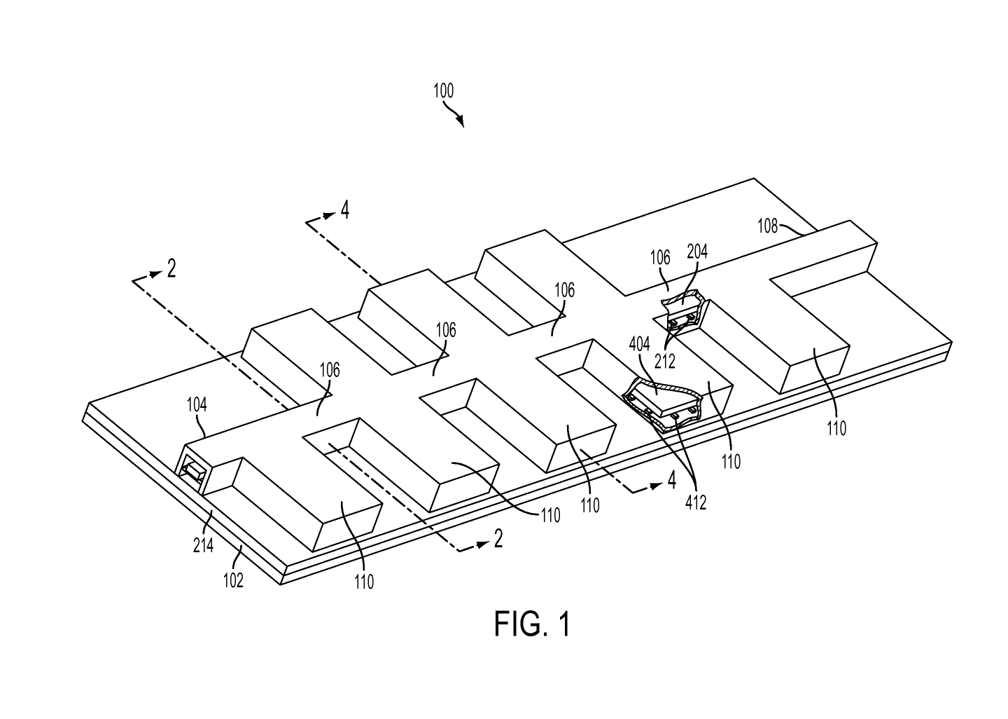

Referring now to FIGS. 1-5, there are illustrated several views of a stub filter 100. The stub filter is formed on a substrate 102 comprised of a dielectric material such as silicon (Si) but can also be formed of other materials such as glass, silicon-germanium (SiGe), or gallium arsenide (GaAs). The stub filter also includes a first conductive layer 214 that defines a ground plane disposed on the substrate 102. The ground plane is formed of a conducive material such as copper (Cu). A series of stub sections 110 are positioned over the first conductive layer. The stub sections are connected by a series of transmission line sections which include terminal transmission line sections 104, 108, and intermediate transmission line sections 106. The terminal transmission line sections 104, 108 are used to communicate RF signals to and from the filter. The intermediate transmission line sections 106 are disposed between and connect adjacent ones of the stub sections 110.

Each of the transmission line sections 102, 104, 106 has a structure which is best understood with reference to FIGS. 1, 2 and 3, which show detailed cross sectional views of an exemplary intermediate transmission line section 106. As illustrated therein, the transmission line section 106 has a structure which includes an outer shield 202 which encloses an interior channel 226. The outer shield 202 is comprised of one or more wall sections 206, 208, 210 which are formed of a plurality of layers of a conductive material, such as copper (Cu). In the embodiment shown, wall sections 208 are aligned transverse to wall sections 206, 207, and 210. More particularly, wall sections 208 are preferably formed so that they are substantially orthogonal to wall sections 206, 207, 210. The number of layers of the electrically-conductive material used to form the walls of the outer shield is application-dependent, and can vary in accordance with a variety of factors. In the embodiment shown, the outer shield 202 is comprised of five layers of conductive material. These include a first conductive layer 214, second conductive layer 216, third conductive layer 218, fourth conductive layer 220 and fifth conductive layer 222. Each layer can have a thickness of, for example, approximately 50 pm, but is not limited in this regard.

The transmission line section also includes a center conductor 204 located approximately in alignment with a central axis defined by the outer shield 202 such that the transmission line section has a structure which is substantially coaxial. In some embodiments, shield 202 has a cross-sectional profile that is rectangular as shown. The center conductor also can have a cross-sectional profile which is substantially rectangular. Accordingly, the transmission line sections 104, 106, 108 can have a rectangular-coaxial (recta-coax) structure. The rectangular profile described herein is preferred because it is well suited to the manufacturing processes which are described below in further detail. However, it should be understood that the invention is not limited in this regard. For example, the shield and/or the center conductor can have other cross-sectional profiles in some embodiments.

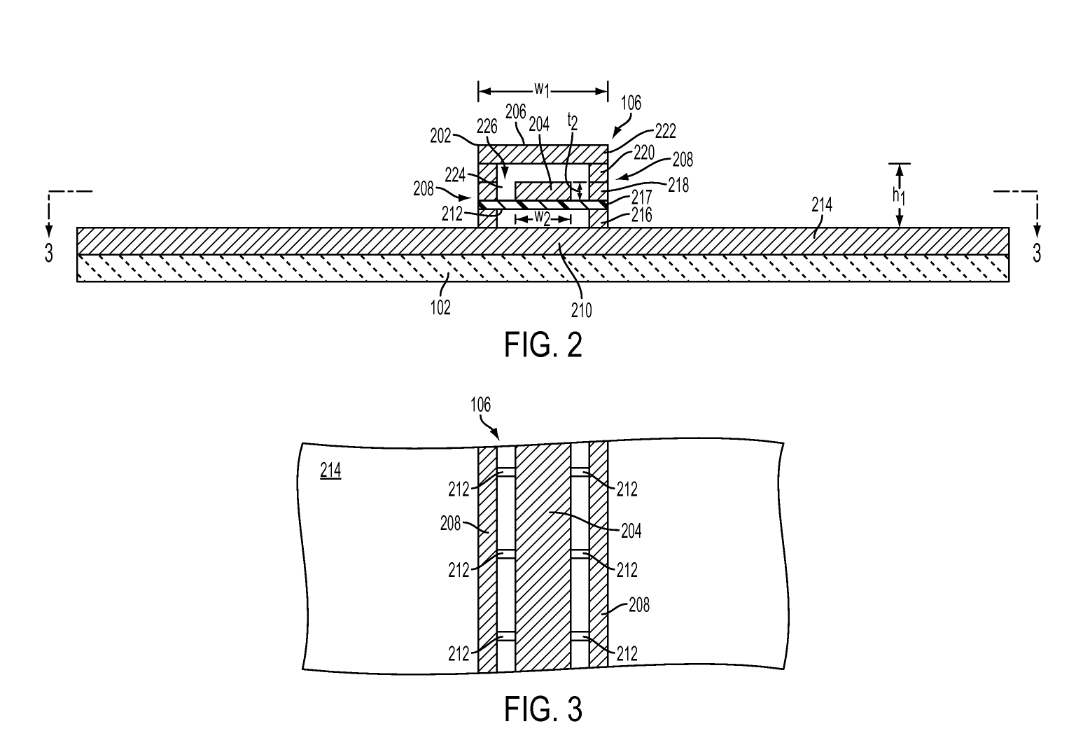

As best understood from FIGS. 2 and 3, the center conductor 204 is suspended within the shield by a plurality of tabs 212 which extend from one or more of the wall sections to the center conductor at spaced intervals along an elongated length of the transmission line. In the illustrated embodiment, the tabs 212 extend from opposing side wall sections 208 to support the center conductor 204. As such, the tabs 212 extend across a width of the channel 226 defined between opposing side wall sections 208. The ends of each tab are sandwiched between portions of the second and third conductive layers that form the side walls 208. The invention is not limited in this regard and the tabs can additionally or alternatively extend from one or more other walls sections. For example, the tabs could extend from wall section 206 and/or 210. According to a preferred embodiment, the tabs are formed of an electrically insulating dielectric material layer 217. Acceptable dielectric materials for this purpose include polyethylene, polyester, polycarbonate, cellulose acetate, polypropylene, polyvinyl chloride, polyvinylidene chloride, polystyrene, polyamide, polyimide, and benzocyclobutene. Still, the invention is not limited in this regard and a wide variety of dielectric materials can be acceptable for use in forming the tabs provided that the material is impervious to chemical attack by a solvent used to dissolve a sacrificial resist. This aspect of the invention is described below in greater detail.

The tabs suspend the center conductor 204 within the shield such that the center conductor is spaced apart from the interior surfaces of the wall sections that form the shield. More particularly, the center conductor is surrounded by and spaced apart from the interior surface of the shield walls by an air gap 224. The air gap 224 acts as a dielectric that electrically isolates the center conductor 204 from the shield 202. In some embodiments, the air gap 224 can be filled with air, but any other gaseous dielectric can also be used for this purpose, provided that such gaseous dielectric has acceptable dielectric properties for the particular application.

Referring now to FIGS. 1, 4 and 5 it can be observed that the stub sections 110 have a structure which is similar to the structure of the transmission line sections described herein. As illustrated therein, the stub section 110 has a structure which includes a housing 402 which encloses a cavity or interior space 426. The housing 402 is comprised of one or more wall sections 406, 408, 410 which are formed of a plurality of layers of conductive material, such as copper (Cu). In the embodiment shown, wall sections 408 are aligned transverse to wall sections 406, 410. More particularly, wall sections 408 are preferably formed so that they are substantially orthogonal to wall sections 406, 410. The number of layers of the electrically-conductive material used to form the walls of the housing is application-dependent, and can vary in accordance with a variety of factors. In the embodiment shown, the housing 402 is comprised of five layers of conductive material. These include the first conductive layer 214, the second conductive layer 216, the third conductive layer 218, the fourth conductive layer 220 and the fifth conductive layer 222.

The stub section also includes a stub element 404 located within the interior space 426. Each stub is electrically connected between respective pair of transmission line sections and generally extends in a direction transverse to a length of each transmission line segment. Each stub will have a shape that is selected in accordance with a filter design. For example, in some embodiments, each stub can be provided as a substantially planar element having a generally rectangular shape when viewed from above, as shown in FIG. 1. Still, the stub elements are not limited in this regard and other shapes are also possible.

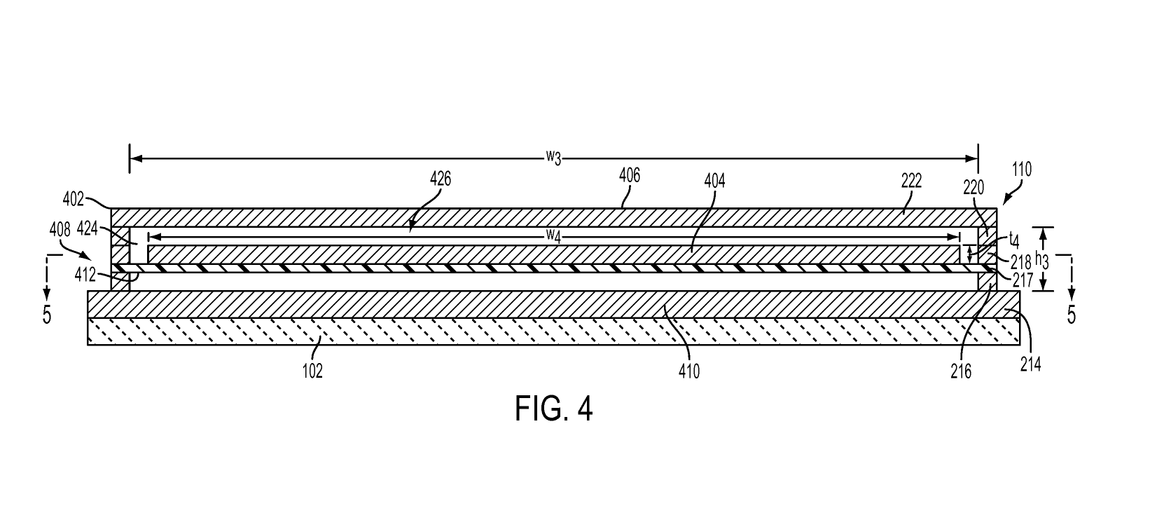

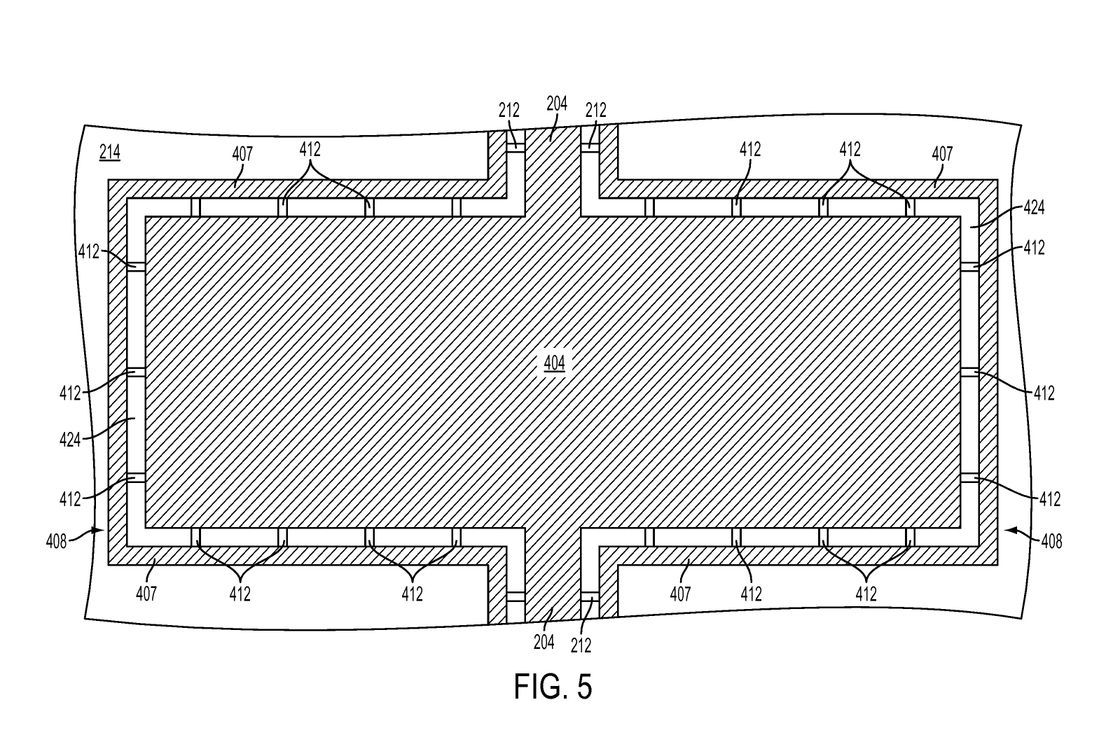

Referring now to FIG. 4, it can be observed that housing 402 has a cross-sectional profile that is rectangular as shown. The stub element also can have a cross-sectional profile which is substantially rectangular; however, it should be understood that the invention is not limited in this regard. As best understood from FIGS. 4 and 5, the stub element 404 is suspended within the housing by a plurality of tabs 412 which extend from one or more of the wall sections. The tabs 412 extend from the walls sections to the stub elements at spaced intervals along a peripheral edge of the stub. In the illustrated embodiment, the tabs 412 extend from opposing side wall sections 408 to support the stub element 404. More particularly, the tabs can extend across a width of the interior space defined between opposing side wall sections 408. The ends of each tab are sandwiched between portions of the second and third conductive layers 216, 218 that form the side walls 408. The invention is not limited in this regard and the tabs can additionally or alternatively extend from different layers or other walls sections. For example, the tabs could extend from wall section 406 or 410. According to a preferred embodiment, the tabs are formed of an electrically insulating dielectric material layer 217. Acceptable dielectric materials for this purpose are the same as those described above with respect to the transmission line sections

The tabs suspend the stub element 404 within the housing 402 such that the stub element is spaced apart from the interior surfaces of the wall sections that form the housing. More particularly, the stub element is surrounded by and spaced apart from the interior surface of the housing walls by an air gap 424. The air gap 424 acts as a dielectric that electrically isolates the stub element 404 from the housing 402. In some embodiments, the air gap 424 can be filled with air, but any other gaseous dielectric can also be used for this purpose, provided that such gaseous dielectric has acceptable dielectric properties for the particular application.

The RF characteristics of the stub filter (e.g. return loss, passband, stopband, ripple, and so on) can be selected using commercially available computer simulation software for modeling RF structures. Techniques for modeling RF structures are well known in the art and therefore will not be described here in detail. However, it should be appreciated that such modeling can facilitate a selection of suitable dimensions for the various elements comprising the filter. For example, computer modeling can be used to select the length and cross-sectional dimensions of the transmission lines 104, 106, 108. Transmission lines 104, 106, 108 can have cross-sectional dimensions and/or lengths which are the same or different. The cross-sectional dimensions of each transmission line can include the width (w₁) and thickness (t₁) of the channel defined by the shield 202, the width (w₂) and thickness (t₂) of the center conductor 204, and so on. As will be appreciated by those skilled in the art, the selection of these dimensions will facilitate design of transmission lines having various characteristic impedance values.

Similarly, computer modeling can be used to select the number of stub elements 110 and the physical dimensions of each of the stub elements. Each stub element and its associated housing 402 will generally have one or more dimensions which are different as compared to the dimensions of the center conductor 204 and shield 202 to which the stub element is connected. For example, the width (w₄) of a stub element will generally be different as compared to the width w₂ of the center conductors to which it is connected. Other dimensions of the stub element can also be different as compared to the center conductors. For example, the thickness t₄ of the stub element can be different as compared to the thickness t₂ of the center conductor. As such, the stub elements generally will be discontinuous with each transmission line section to which it is connected, in the sense that the structures will have relatively different cross-sectional dimensions. Moreover, each of the stub elements 110 can have dimensions that are the same or different. Finally, computer modeling can also be used to select the width (w₃) and height (h₃) of the interior space defined within housing 402. The width and height of the interior space can be the same or different as compared to the width and height of the channel contained with the shield. Notably, FIGS. 1-5 show that five layers of conductive material are used to form the walls 208, 408. Fabrication of the filter 100 will be discussed in more detail below, but it should be appreciated that variations in the height of the housing as compared to the height of the shield may necessitate more or fewer layers of conductive material for purposes of forming walls 208, 408.

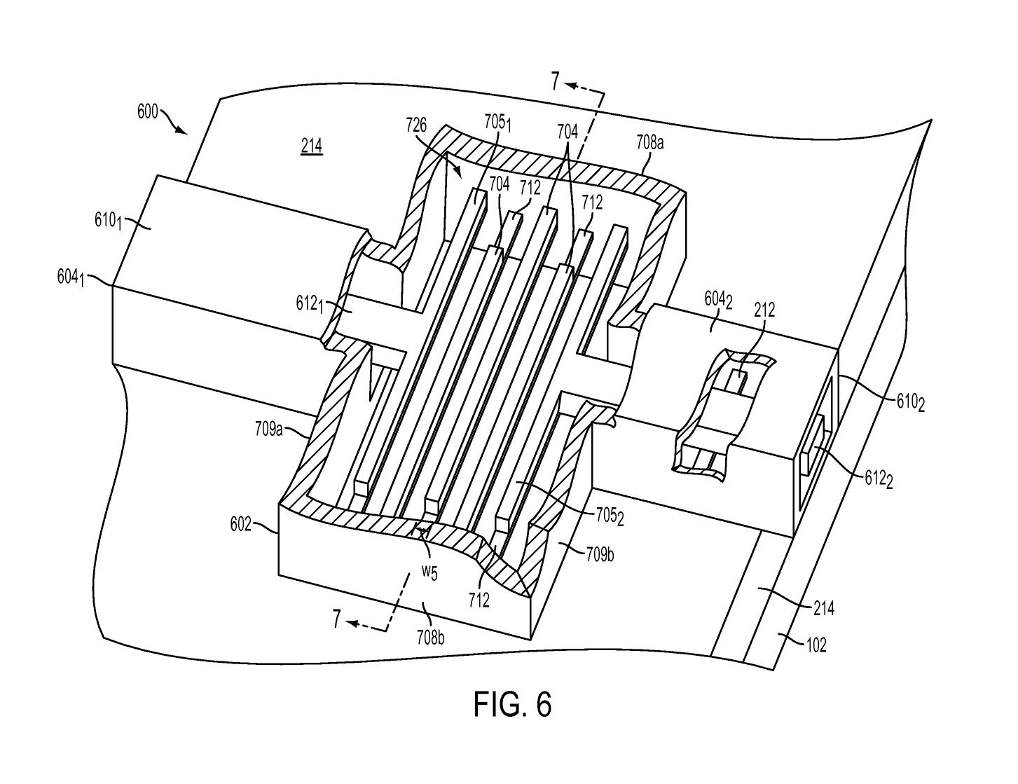

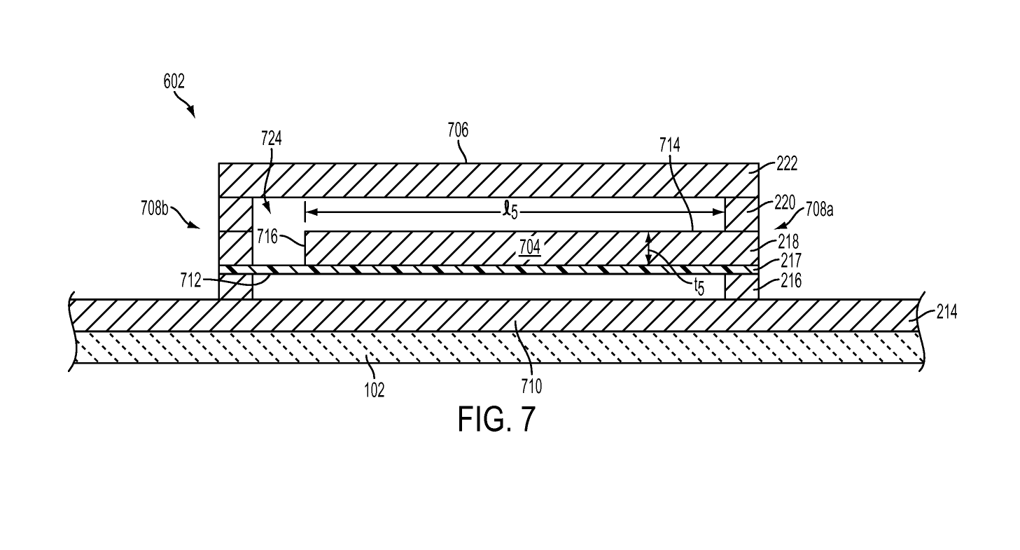

Referring now to FIGS. 6 and 7, there is illustrated an embodiment of the invention in the form of a combline filter. Certain aspects of the combline filter 600 are similar as compared to the stub filter. Accordingly, common reference numbers are used when appropriate to refer to corresponding material layers comprising each embodiment.

The combline filter is formed on a substrate 102 comprised of a dielectric material such as silicon (Si) but can also be formed of other materials such as glass, silicon-germanium (SiGe), or gallium arsenide (GaAs). The combline filter include a ground plane comprised of a first conductive layer 214 disposed on the substrate 102. The ground plane is formed of a conducive material such as copper (Cu). The combline filter includes terminal transmission line sections 604₁, 604₂ which are used to communicate RF signals to and from the filter. The terminal transmission line sections 604₁, 604₂ are similar to the exemplary transmission line section 106 described above with respect to FIGS. 2 and 3. As such, the previously described materials, structure and features of exemplary transmission line section 106 are also applicable to terminal transmission lines 604₁, 604₂. The terminal transmission line sections can similarly be comprised of a plurality of layers (e.g., 214, 216, 217, 218, 220, and 222) as described with respect to FIGS. 2 and 3. In FIG. 6, the outer shields of the terminal transmission lines 604₁, 604₂ are designated as reference numbers 610₁, 610₂ and the center conductor is designated by reference numbers 612₁, 612₂.

The terminal transmission lines 604₁, 604₂ are connected to housing 602 which defines an interior space 726. Within the interior space there are provided a plurality of distributed elements, including terminal elements 705₁ and 705₂, and intermediate elements 704. The housing 602 is comprised of one or more wall sections 706, 708a, 708b, 709a, 709b, 710 which are formed of a plurality of layers of conductive material layers. In the embodiment shown, wall sections 708a, 708b are aligned transverse to wall sections 706, 710. More particularly, wall sections 708a, 708b are preferably formed so that they are substantially orthogonal to wall sections 706, 710. The number of layers of the electrically-conductive material used to form the walls of the housing 602 is application-dependent, and can vary in accordance with a variety of factors. In the embodiment shown, the housing 602 is comprised of five layers of conductive material. For example these layers can include a first conductive layer formed of first conductive layer 214, second conductive layer 216, third conductive layer 218, fourth conductive layer 220 and fifth conductive layer 222. The outer shields 604₁, 604₂ of the terminal transmission line sections are integrally formed with the housing 602 and form an electrical connection therewith. The center conductors 612₁, 612₂ are electrically connected to the terminal elements 705₁ and 705₂ and help suspend them within the interior space 726 as described below.

Each of the terminal elements and intermediate elements generally extends in a direction transverse to a length of each transmission line 604₁, 604₂. The length, width and thickness of each intermediate and terminal element is selected in accordance with a filter design. Similarly, a gap between adjacent ones of the terminal elements and intermediate elements is determined in accordance with a filter design. As shown in FIG. 6, each of the terminal elements and intermediate elements can have a geometric shape which essentially a rectangular prism. Still, the terminal elements and intermediate elements are not limited in this regard and other shapes are also possible.

Each of the terminal elements 705₁, 705₂ and intermediate elements 704 is integrally formed at one end thereof with a side wall of the housing 602. This concept can be understood with reference to FIG. 7, which shows an intermediate element 704 is integrally formed at a first end 714 with side wall 708a. A second end 716 of the intermediate element is suspended in a position spaced apart from an opposing side wall 708b, such that the second end 716 is separated from the side wall 708b by an air gap. The terminal elements and intermediate elements are alternately connected to opposing ones of the side walls 708a, 708b as shown.

Each of the terminal elements and intermediate elements is suspended within the housing by a plurality of tabs 712 which extend from one or more of the wall sections. The tabs can extend across a width of the interior space 726 defined between opposing side wall sections 708a, 708b as shown. The ends of each tab are sandwiched between portions of the second and third conductive layers 216, 218 that form the side walls 708a, 708b. The invention is not limited in this regard and the tabs can additionally or alternatively extend from different layers or other walls sections or not at all. For example, in some embodiments, the tabs could extend from wall sections 706, 709a, 709b, and/or 710. According to a preferred embodiment, the tabs are formed of electrically insulating dielectric material layer 217. Acceptable dielectric materials for this purpose are the same as those described above with respect to the transmission line sections

The tabs suspend the terminal elements and the intermediate elements within the housing 602 such that each element is generally maintained spaced apart from the interior surfaces of the wall sections that form the housing. Of course, the exception to this is the end (e.g. end 714) at which the terminal elements and intermediate elements are integrally joined to a respective wall (e.g. 708a, 708b) of the housing. With the foregoing arrangement, terminal elements and intermediate elements are generally surrounded by and spaced apart from the interior surface of the housing walls by an air gap 724, except for those portions which are attached to the side walls 708a, 708b. The air gap 724 is a dielectric that electrically isolates the element 704, 705₁, 705₂ from the housing 702. In some embodiments, the air gap 724 can be filled with air, but the invention is not limited in this regard and any other gaseous dielectric can also be used for this purpose, provided that such gaseous dielectric has acceptable dielectric properties for the particular application.

The RF characteristics of the combline filter (e.g. return loss, passband, stopband, ripple, and so on) can be selected using commercially available computer simulation software for modeling RF structures. Techniques for modeling RF structures are well known in the art and therefore will not be described here in detail. However, it should be appreciated that such modeling can facilitate a selection of suitable dimensions for the various elements comprising the filter. For example, computer modeling can be used to select the length and cross-sectional dimensions of the terminal transmission lines 604₁, 604₂. The terminal transmission lines 604₁, 604₂ can have cross-sectional dimensions and/or lengths which are the same or different. As will be appreciated by those skilled in the art, the selection of these dimensions will facilitate design of transmission lines having various characteristic impedance values.

Similarly, computer modeling can be used to select the number of intermediate elements 704 and the physical dimensions of each of the terminal and intermediate elements. The various dimensions of each intermediate element and terminal element 704, 705₁, 705₂ can be adjusted to achieve different filter responses. For example, the thickness (t₅), length (l₅), and width (w₅) can be selected to provide a desired filter response. Similarly, a spacing or gap between adjacent ones of the terminal elements and intermediate elements can be selected to provide a suitable filter response. These values can be determined using commercially available software for modeling RF structures.

The width and height of the interior space 726 defined by housing 602 can be the same or different as compared to the width and height of the channel contained within the shield 610₁, 610₂. Fabrication of the filter 600 will be discussed in more detail below, but it should be appreciated that variations in the height of the housing 602 may necessitate more or fewer layers of conductive material for purposes of forming walls 708a, 708b, 709a, 709b and such embodiments are contemplated as coming within the scope of the present invention.

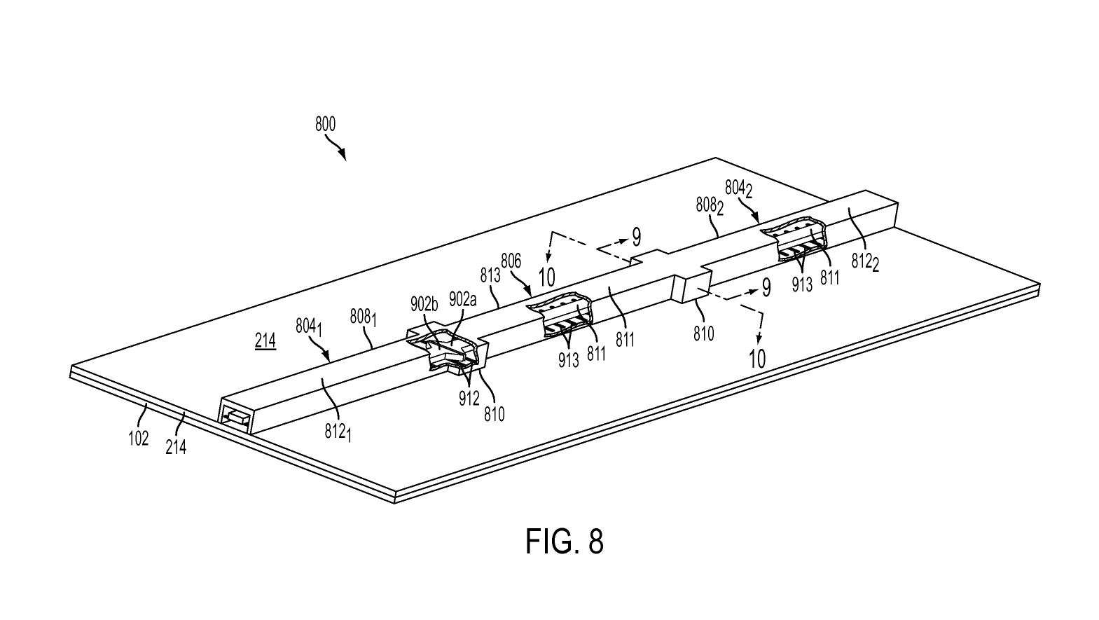

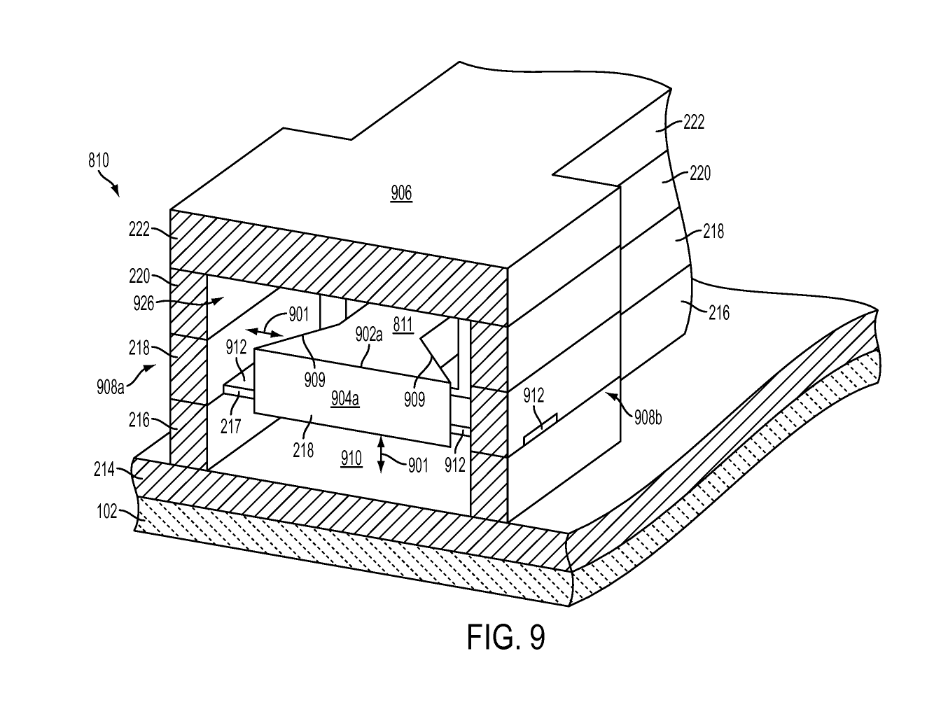

Referring now to FIGS. 8-10, there is illustrated an embodiment of the invention in the form of an edge coupled filter 800. Certain aspects of the edge coupled filter 800 are similar as compared to the stub filter and combline filter described above. For example, the edge coupled filter can be comprised of a plurality of layers similar to those previously described in relation to FIGS. 1-7. Accordingly, common reference numbers are used when appropriate to refer to material layers in FIGS. 8 and 9 which correspond to material layers previously discussed in FIGS. 1-7.

The edge coupled filter 800 is formed on a dielectric substrate 102 and can include a first conducive layer 214 that forms a conductive ground plane. The edge coupled filter includes terminal transmission line sections 804₁, 804₂ which are used to communicate RF signals to and from the filter. The edge coupled filter can also include one or more intermediate transmission line sections 806 which are used to interconnect two or more edge coupled sections 810. Each of the terminal transmission line sections 804₁, 804₂ and the intermediate transmission line section(s) 806 are similar to the exemplary transmission line section 106 described above with respect to FIGS. 2 and 3. As such, the previously described materials, structure and features of exemplary transmission line section 106 are also applicable to terminal transmission lines 804₁, 804₂ and intermediate transmission line section(s) 806. The terminal transmission line sections 804₁, 804₂ and intermediate transmission line section(s) 806 can also be comprised of a plurality of layers (e.g., 216, 217, 218, 220, and 222) as previously described. In FIG. 8, the outer shields of the terminal transmission lines 804₁, 804₂ are designated as reference numbers 808₁, 808₂ and the center conductors are designated by reference numbers 812₁, 812₂. The outer shield of intermediate transmission line 806 is designated by reference number 813 and the center conductor is indicated by reference number 811.

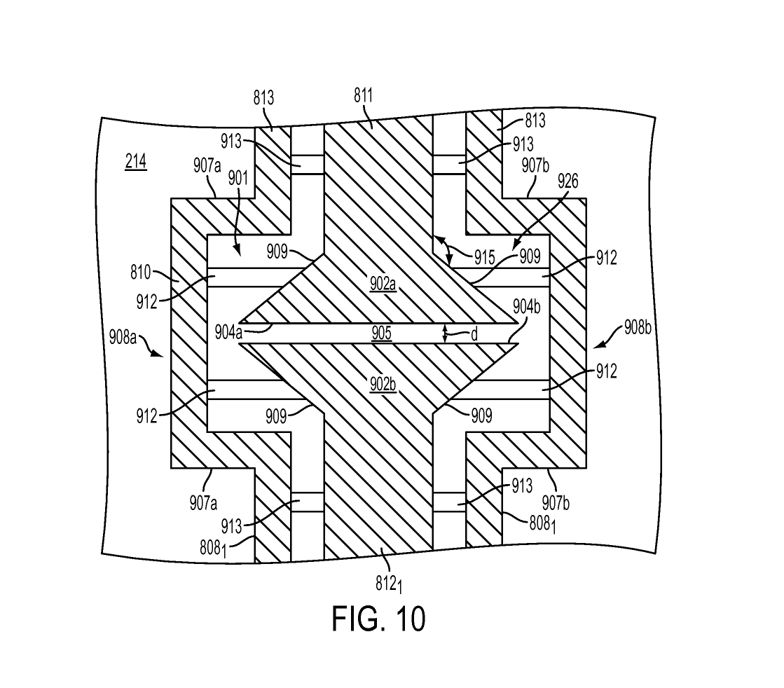

The terminal transmission lines 804₁, 804₂ are connected to housings 810, each of which defines an interior space 926. Within the interior space of each housing there is provided a distributed element, which is comprised of terminal elements 902a and 902b separated by an air gap 905. Each of the two or more housings 810 and its associated distributed element can have a similar design which is best understood with reference to FIGS. 9 and 10. Still, it should be understood that the geometry and dimensions of these components need not be the same. Instead, these design details can be selected to facilitate a particular filter design. Accordingly, the geometry shown in FIGS. 9 and 10 is exemplary and merely intended as an aid to understanding the invention.

Each housing 810 is comprised of one or more wall sections 906, 908a, 908b, 910 which are formed of a plurality of layers of conductive material layers. Wall sections 906 are preferably aligned substantially parallel to each other and orthogonal to side walls 908a, 908b. Wall sections 908a, 908b are formed so that they are substantially orthogonal to wall sections 907a, 907b. Still, the invention is not limited in this regard and other arrangements are also possible. For example, each of wall sections 907a, 907b can extend in parallel alignment with chamfered edges 909.

The number of layers of the electrically-conductive material used to form the walls of the housing 810 is application-dependent, and can vary in accordance with a variety of factors. In the embodiment shown, the housing 810 is comprised of five layers of conductive material. For example these layers can include a first conductive layer formed of first conductive layer 214, second conductive layer 216, third conductive layer 218, fourth conductive layer 220 and fifth conductive layer 222 as shown. As best shown in FIG. 10, the outer shields 808₁, 808₂ of the terminal transmission line sections are integrally formed with the housings 810 and form an electrical connection therewith. The center conductors 812₁, 812₂ are electrically connected to the terminal elements 902a and 902b and help suspend them within the interior space 926 as described below.

The exact geometry and dimensions of each terminal element 902a, 902b is selected in accordance with a filter design. Similarly, a gap 905 between opposing faces 904a, 904b of adjacent terminal elements is determined in accordance with a filter design. As shown in FIGS. 9 and 10, each of the terminal elements 902a, 902b can have a geometric shape which includes chamfered edges 909 which extend respectively from the transmission line center conductor (e.g. 812₁, 811) to a terminal element face 904a, 904b. The relatively broad surface thus defined by the terminal element faces 904a, 904b enhances capacitive coupling between terminal elements 902a, 902b. Still, the terminal elements and intermediate elements are not limited in this regard and other shapes are also possible.

Each of the terminal elements is integrally joined at one end thereof with a center conductor of a transmission line. For example, terminal elements 902a, 902b are shown to be integrally formed with terminal transmission line 812₁ and intermediate transmission line 811 in FIGS. 9 and 10. In some embodiments, the terminal elements are also supported or suspended within the housing by a plurality of tabs 912 which extend from one or more of the walls of the housing. The tabs can extend across a width of an interior space defined between opposing side wall sections 908a, 908b as shown. As best shown in FIG. 9, the ends of each tab are sandwiched between portions of the second and third conductive layers 216, 218 that form the side walls. The invention is not limited in this regard and the tabs can additionally or alternatively extend from different layers and/or other walls sections. For example, in some embodiments, the tabs could extend from wall sections 906, and/or 910. According to a preferred embodiment, the tabs are formed of electrically insulating dielectric material layer 217. Acceptable dielectric materials for this purpose are the same as those described above with respect to the transmission line sections

The terminal elements are suspended in a position spaced apart from the walls of the housing 810. The tabs suspend the terminal elements such that each is generally maintained spaced apart from the interior surfaces of the wall sections that form the housing. With the foregoing arrangement, terminal elements and intermediate elements are generally surrounded by and spaced apart from the interior surface of the housing walls by an air gap 901. The air gap 901 is comprised of a dielectric that electrically isolates the terminal elements from the housing In some embodiments, the air gap can be filled with air, but the invention is not limited in this regard and any other gaseous dielectric can also be used for this purpose, provided that such gaseous dielectric has acceptable dielectric properties for the particular application.

The RF characteristics of the edge coupled filter (e.g. return loss, passband, stopband, ripple, and so on) can be selected using commercially available computer simulation software for modeling RF structures. For example, computer modeling can be used to select a chamfer angle 915, cross-sectional area of the terminal element faces 904a, 904b, and a distance (d) between the opposing faces. The filter design can include transmission line sections which have the same or different impedance values. As such, terminal transmission lines 804₁, 804₂ and intermediate transmission line section 811 can have a cross-sectional dimensions which are the same or different. The impedance values and length of these transmission lines can be selected to facilitate a particular filter design

The height, width and geometry of the interior space 926 defined by housing 810 can be different as compared to the width and height of the channel contained within the shields 808₁, 808₂. and 813. Fabrication of the filter 800 will be discussed in more detail below, but it should be appreciated that variations in the height of the housing 810 may necessitate more or fewer layers of conductive material for purposes of forming walls 908a, 908b, 907a, 907b. All such embodiments are contemplated as coming within the scope of the present invention.

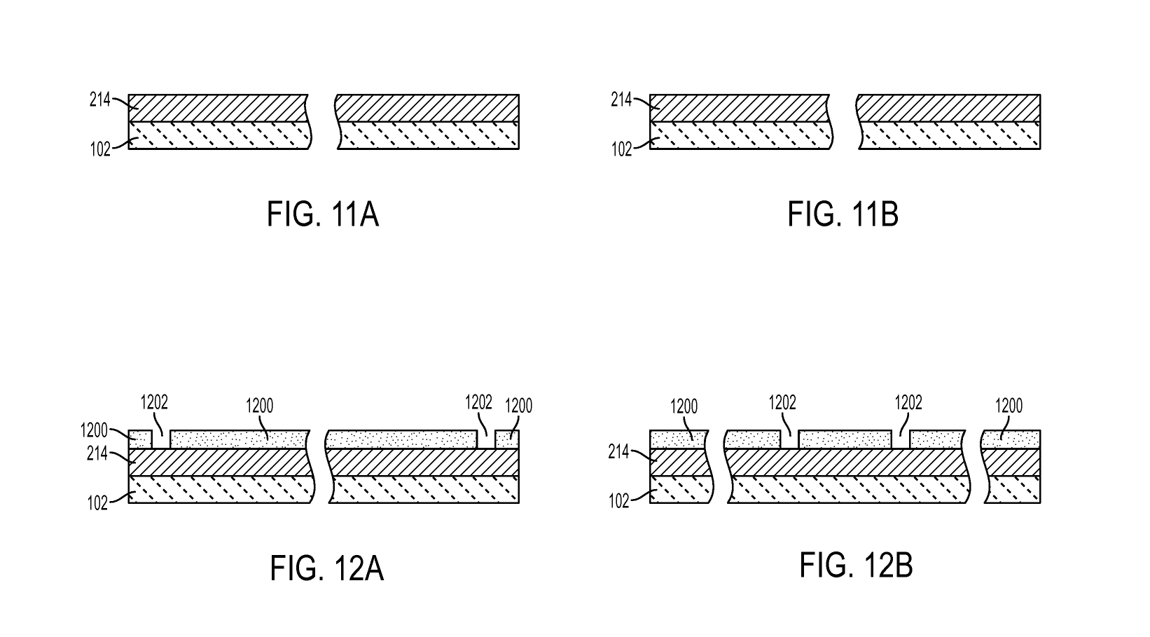

A process for fabricating distributed element filter structures similar to those described in FIGS. 1-10 will now be described in further detail with respect to FIGS. 11A-21B. The filter structures described herein can be manufactured using known processing techniques for creating three-dimensional microstructures, including coaxial transmission lines. For example, the processing methods described in U.S. Pat. Nos. 7,898,356 and 7,012,489, the disclosure of which is incorporated herein by reference, can be adapted and applied to the manufacture of the filter structures disclosed herein. The process will be described herein with respect to the stub filter in FIGS. 1-5, but it should be appreciated that similar techniques can be used to form the combline filter, the edge coupled filter, and other types of distributed element RF filters. A photolithography process can be used to form the various layers as hereinafter described. Photolithography is well known in the art and therefore will not be described here in detail. However, a brief explanation of the process is provided where appropriate as an aid to understanding the invention. Also, some of the below steps are described as being implemented using a positive or negative type photoresist. In each instance, it should be appreciated that the invention is not limited with regard to the particular type of photoresist used. Commercially available photoresist chemicals have advantages and disadvantages in various different applications. Accordingly, the choice of a positive or negative type of photoresist is determined based on a variety of factors, including the materials used to form the various layers of the filters.

Referring now to FIGS. 11A-11B, a first conductive layer 214 forms a ground plane which is disposed on substrate 102. The first conductive layer can be applied using any suitable process. For example, the layer can be formed by depositing a conductive material on the substrate 102 to a predetermined thickness. The deposition of the electrically-conductive material can be accomplished using a suitable technique such as chemical vapor deposition (CVD). Other suitable techniques, such as physical vapor deposition (PVD), sputtering or electroplating, can be used in the alternative. The upper surfaces of the newly-formed first layer can be planarized using a suitable technique such as chemical-mechanical planarization (CMP).

In FIGS. 12A-12B a photoresist masking layer 1200 is applied to the partially-constructed filter 100 by patterning a photoresist material in a desired pattern over the first conductive layer 214. As is well known in the art, a photoresist is a light sensitive material that is used in photolithography to form a patterned coating on a surface. A positive photoresist is not generally soluble by a photoresist developer solution unless the photoresist is exposed to a suitable wavelength of light. Portions of the photoresist are intentionally selectively exposed to the light using a mask so that those exposed portions become soluble to the photoresist developer. By depositing a layer of photoresist 1200 on a surface (e.g. first conductive layer 214) and selectively controlling which portions of the photoresist are exposed to the light, a pattern of soluble photoresist if formed. The layer of photoresist is then exposed to a photoresist developer and the soluble portions are dissolved to create a pattern formed of the photoresist.

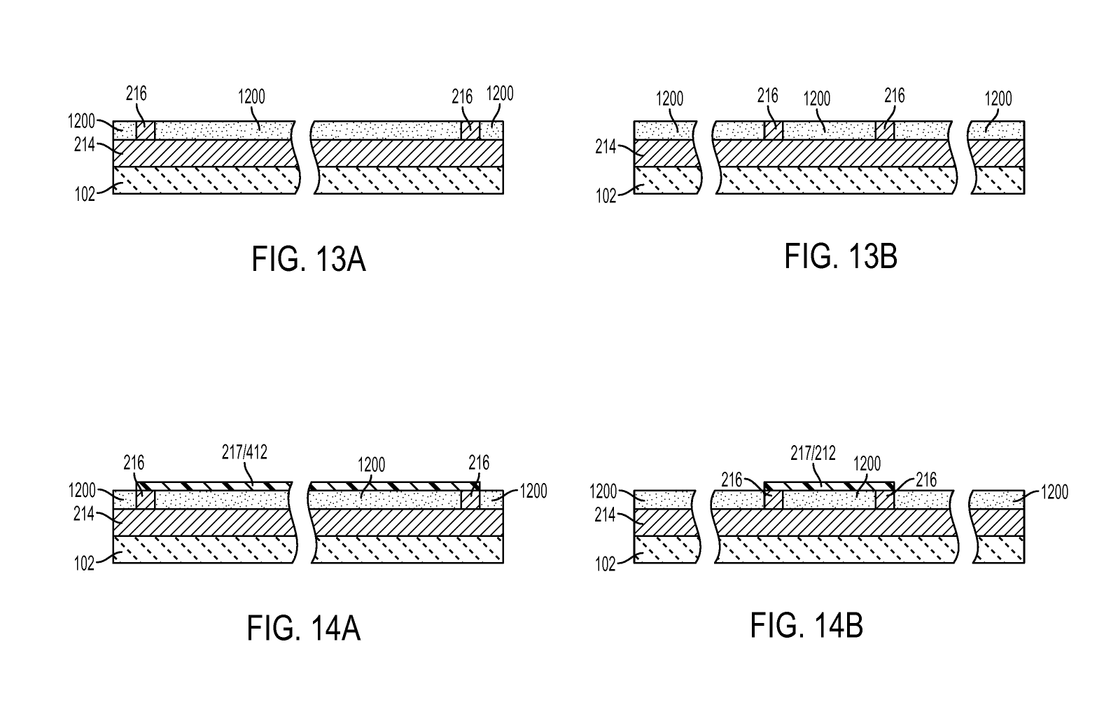

The areas where the photoresist has been dissolved leaves portions of the first conductive layer 214 exposed through a pattern of openings 1202 formed in the photoresist layer 1200. In FIGS. 12A-12B, the exposed areas on the partially-constructed filter 100 correspond to the locations at which the above-noted side wall sections 208, 407, 408 are to be located. The electrically-conductive material can subsequently be deposited on the exposed portions 1202 of the partially constructed filter 100 to a predetermined thickness, to form the second conductive layer 216 of the electrically-conductive material as shown in FIGS. 13A and 13B. The upper surfaces of the newly-formed portions of the partially constructed filter 100 can then be planarized.

Referring now to FIGS. 14A-14B, a photolithography process can also be used to deposit a dielectric material layer 217 in a predetermined pattern for purposes of forming tabs 212, 412. The process is similar to that described above with respect to FIGS. 11A-13B, except that a dielectric layer 217 is deposited instead of a conductive layer. Also, it can be advantageous to use a negative photoresist for purposes of forming the dielectric layer 217. The dielectric material that forms the tabs 212, 412 can be deposited and patterned on top of the previously-formed photoresist layer as shown in FIGS. 14A and 14B.

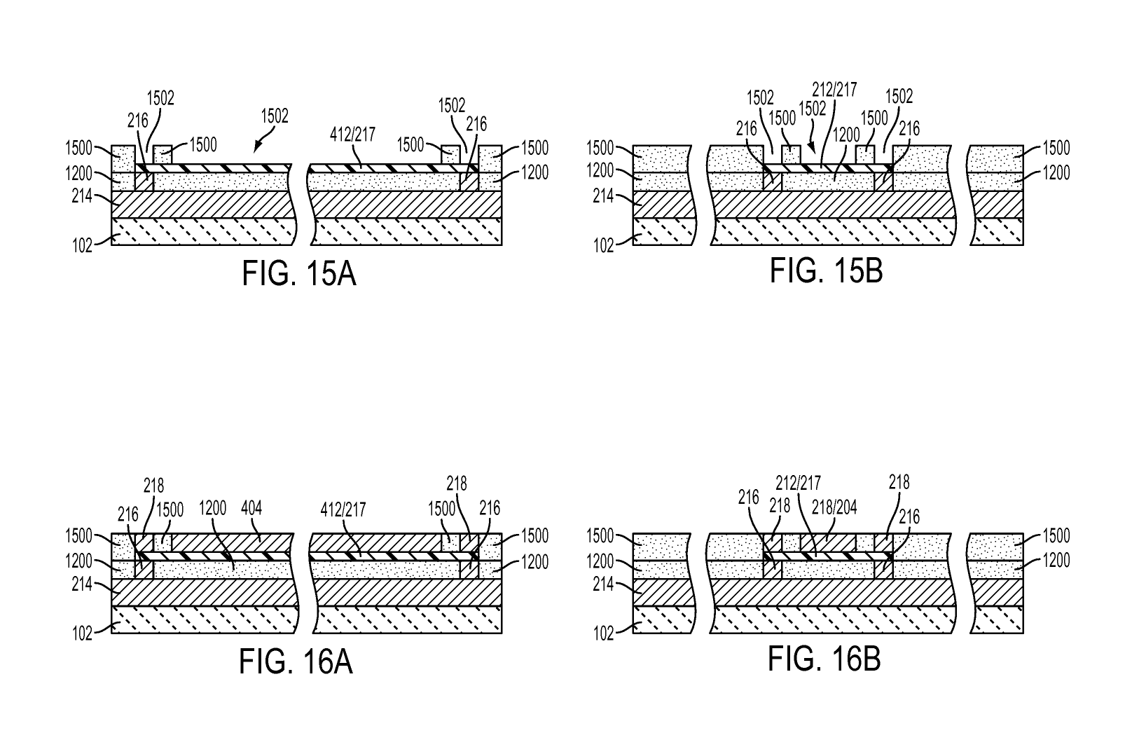

Referring now to FIGS. 15A-16B, the process continues by forming the third conductive layer 218 which forms center conductor 204, stub element 404; and additional portions of the sides of the transmission line shield 202, housing 402. A photoresist layer 1500 is applied to the partially-constructed filter 100. In FIGS. 15A-15B the photoresist layer 1500 is patterned so that exposed areas 1502 on the partially-constructed filter correspond to the locations at which the above-noted components (204, 404) are to be located. The electrically-conductive material is subsequently deposited in the exposed areas 1502 of the partially constructed filter 100 to a predetermined thickness. This electrically conductive material forms the third conductive layer 218 of the electrically-conductive material as shown in FIGS. 16A and 16B. The upper surfaces of the newly-formed portions of the partially constructed filter 100 can then be planarized.

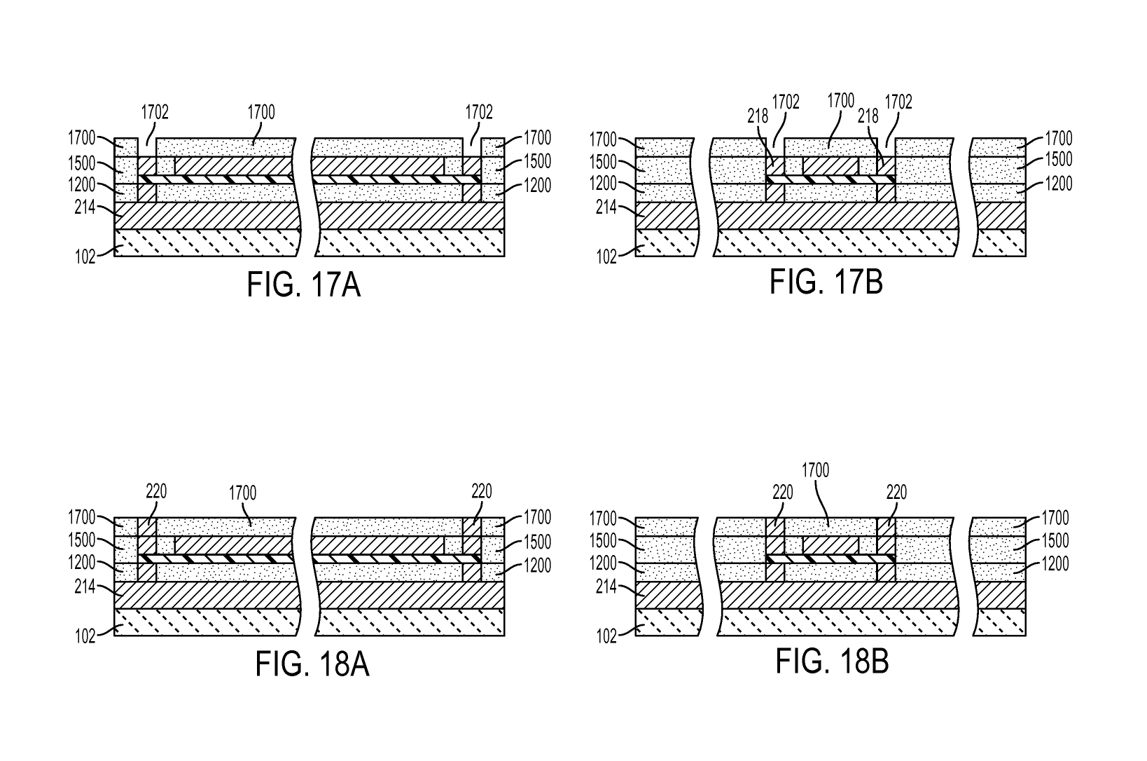

The fourth conductive layer 220 of the electrically conductive material forms additional portions of the sides of the shield 202 and housing 402. The fourth conductive layer is formed in a manner similar to the first, second, and third layers. In particular, the fourth conductive layer is formed by applying a photoresist material to the previously-formed layers to form a photoresist layer 1700, as in FIGS. 17A and 17B, with exposed portions 1702. Thereafter, additional electrically-conductive material is deposited to the exposed areas to form the fourth conductive layer as shown in FIGS. 18A and 18B. The upper surfaces of the newly-formed portions of the partially constructed filter 100 can be planarized after the application of the fourth layer.

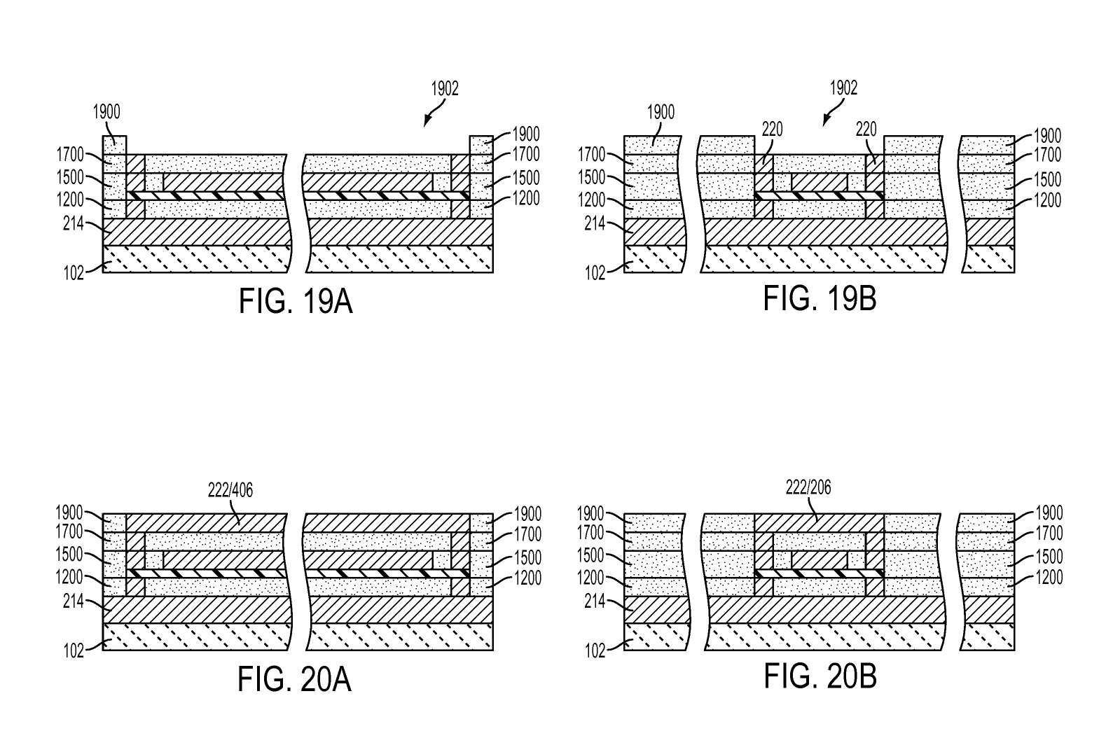

The fifth conductive layer 222 forms additional portions of the sides of the shield 202 and housing 402, including wall sections 206, 406. The fifth conductive layer is formed in a manner similar to the first, second, third, and fourth conductive layers. In particular, the fifth conductive layer is formed by applying photoresist to the previously-formed layers to form a photoresist layer 1900, as shown in FIGS. 19A and 19B. Additional electrically-conductive material is deposited to the exposed areas 1902 to form the fifth conductive layer 222 as shown in FIGS. 20A and 20B. The upper surfaces of the newly-formed portions of the partially constructed filter 100 can be planarized after the application of the fifth layer.

Referring now to FIGS. 1-5 and 11A-20B the result of the foregoing steps is a filter assembly includes a plurality of layers of a material arranged in a stack. The stack includes conductive material layers (214, 216, 218, 220, 222) that form at least one transmission line including a shield 202 and a center conductor 204 disposed coaxially within the shield. The conductive material layers also form at least one distributed filter element (e.g. stub section 404) electrically coupled to the center conductor, and at least one housing 402 electrically coupled to the shield 202. The housing is comprised of walls which enclose at least one distributed filter element. The filter assembly also includes one or more layers 217 of dielectric material arranged to form two or more tabs extending from at least one shield wall 208 to the center conductor 204 at spaced intervals along an elongated length of the center conductor. One or more tabs 412 also support the distributed filter element 404. One or more layers of sacrificial material (i.e. photoresist) fills the channel defined by the shield, including a clearance space between the center conductor and each of one or more shield walls. The sacrificial material also fills an interior space defined by at least one housing, including a second clearance space between at least one distributed filter element and each of the plurality of housing walls. The sacrificial material supports the center conductor and the distributed filter element during a manufacturing process which includes the formation of the tabs. The sacrificial material is selectively dissolvable after the manufacturing process is complete without causing damaging or degrading the structures formed by the conductive material and the dielectric material.

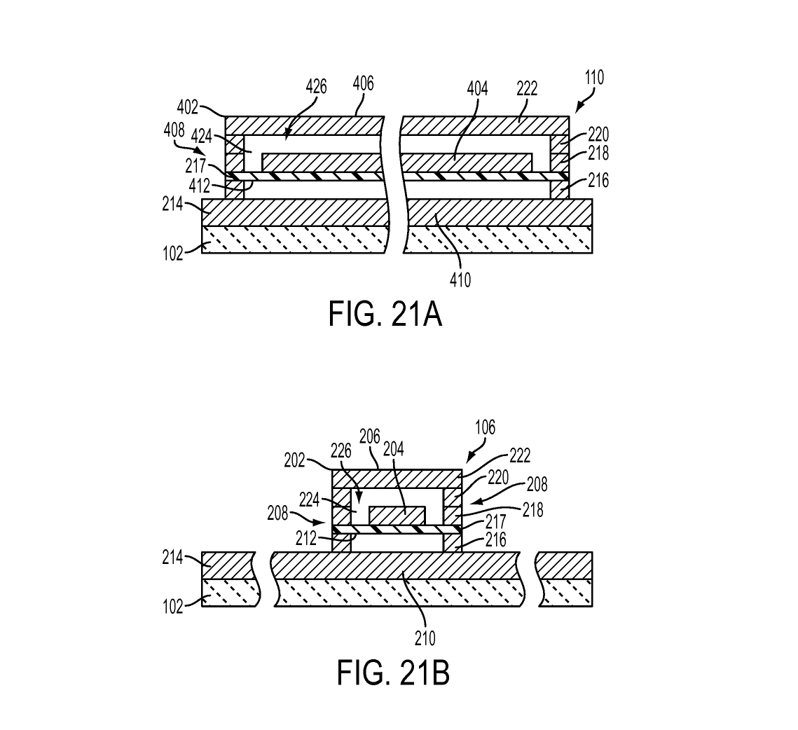

The photoresist material remaining from each of the masking steps is a sacrificial material that can be removed or released after application of the fifth conductive layer has been completed as depicted in FIGS. 21A and 21B, for example, by exposing the photoresist material to an appropriate solvent that causes the photoresist material to evaporate or dissolve. The solvent can be selected so that it is capable of dissolving sacrificial photoresist material which has been through multiple cycles of curing, baking and so on.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

We claim:

1. A method for constructing a radio frequency filter, comprising:
depositing on a surface of a dielectric substrate a plurality of layers including at least one layer each of a conductive material, a dielectric material, and a sacrificial material;
controlling a deposit of said at least one layer of conductive material to form:
at least one transmission line including a shield and a center conductor disposed coaxially within said shield,
at least one distributed filter element electrically coupled to said center conductor, and
at least one housing electrically coupled to said shield and including a plurality of housing walls enclosing said at least one distributed filter element; and
dissolving said at least one layer of said sacrificial material to form:
a channel disposed within said at least one shield, including a first clearance space between said center conductor and each of one or more shield walls, whereby said center conductor resides in said channel spaced apart from said shield walls, and
an interior space disposed within said at least one housing, including a second clearance space between said at least one distributed filter element and each of said plurality of housing walls, whereby said at least one distributed filter element resides in said interior space spaced apart from said housing walls.

2. The method according to claim 1, further comprising controlling a deposit of said at least one layer of dielectric material to form a first plurality of tabs extending from at least one said shield wall to said center conductor for suspending said center conductor within said channel.

3. The method according to claim 2, further comprising controlling said deposit of said at least one layer of dielectric material to position each of said first plurality of tabs at spaced intervals along an elongated length of said center conductor.

4. The method according to claim 3, wherein said dissolving step further comprises dissolving said sacrificial material between adjacent ones of said first plurality of tabs.

5. The method according to claim 1, further comprising controlling a deposit of said at least one layer of dielectric material to form a second plurality of tabs extending from at least one of said plurality of housing walls to said at least one distributed filter element for suspending said at least one distributed filter element within said interior space.

6. The method according to claim 5, further comprising controlling said deposit of said at least one layer of dielectric material to position said second plurality of tabs at spaced intervals around a periphery of said at least one distributed filter element.

7. The method according to claim 6, wherein said dissolving step further comprises dissolving said sacrificial material between adjacent ones of said second plurality of tabs.

8. The method according to claim 1, further comprising controlling said deposit of said at least one layer of conductive material to form a plurality of said distributed filter elements within said interior space.

9. The method according to claim 1, further comprising controlling said deposit of said at least one layer of conductive material to provide a galvanic electrical connection between at least one of said distributed filter elements and one of said housing walls.

10. The method according to claim 1, further comprising controlling said deposit of said at least one layer of conductive material to form said at least one distributed filter element with a predetermined length, width and thickness necessary for obtaining a predetermined frequency response when an RF signal is applied to said at least one transmission line.

11. The method according to claim 10, further comprising controlling said deposit of said at least one layer of conductive material to form a plurality of said housings, each containing at least one of said distributed filter elements.

12. The method according to claim 11, further comprising controlling said deposit of said at least one layer of conductive material to form at least a second one of said transmission lines to couple at least a first distributed filter element in a first one of said housings with at least a second distributed filter element in a second one of said housings.

13. The method according to claim 1, further comprising controlling said deposit of said at least one layer of conductive material to form said at least one distributed filter element as a stub, galvanically connected to said transmission line center conductor.

14. The method according to claim 1, further comprising controlling said deposit of said at least one layer of conductive material to form said at least one distributed filter element to include a first transmission line end face, separated from a second transmission line end face by a gap.

15. A radio frequency filter assembly, comprising:
a dielectric substrate;
a plurality of layers of a conductive material arranged in a stack to form:
at least one transmission line including a shield and a center conductor disposed coaxially within said shield,
at least one distributed filter element electrically coupled to said center conductor, and
at least one housing electrically coupled to said shield and including a plurality of housing walls enclosing said at least one distributed filter element; and
at least one layer of said dielectric material arranged to form a first plurality of tabs extending from at least one said shield wall to said center conductor at spaced intervals along an elongated length of said center conductor; and
at least one layer of said sacrificial material which fills:
a channel defined by said at least one shield, and a first clearance space between said center conductor and each of one or more shield walls, and
an interior space defined by said at least one housing, including a second clearance space between said at least one distributed filter element and each of said plurality of housing walls, whereby said at least one distributed filter element resides in said interior space spaced apart from said housing walls; and
wherein said sacrificial material is configured to support said center conductor and said distributed filter element during a manufacturing process, and wherein said sacrificial material is one which is selectively dissolvable exclusive of damage to said conductive material and said dielectric material.

16. The radio frequency filter assembly according to claim 15, further comprising a second plurality of tabs extending from at least one of said plurality of housing walls to said at least one distributed filter element, said second plurality of tabs arranged at spaced intervals around a periphery of said at least one distributed filter element.

17. The radio frequency filter assembly according to claim 15, wherein at least one of said plurality of layers of conductive material is arranged to form a plurality of said distributed filter elements within said channel.

18. The radio frequency filter assembly according to claim 17, wherein at least one of said distributed filter elements is integrally formed with one of said housing walls to form a galvanic electrical connection between said housing wall and said distributed filter element.

19. The radio frequency filter assembly according to claim 15, wherein said at least one distributed filter element has a predetermined length, width and thickness to provide a predetermined frequency response under conditions where said sacrificial material has been dissolved and an RF signal is applied to said at least one transmission line.

20. The radio frequency filter assembly according to claim 15, wherein said plurality of layers of conductive material form a plurality of said housings, each containing at least one of said distributed filter elements.

21. The radio frequency filter assembly according to claim 20, wherein said plurality of layers of conductive material form at least a second one of said transmission lines to couple at least a first distributed filter element in a first one of said housings with at least a second distributed filter element in a second one of said housings.

22. The radio frequency filter assembly according to claim 15 wherein said at least one distributed filter element is a stub, galvanically connected to said transmission line center conductor and suspended with said housing by a plurality of dielectric tabs.

23. The radio frequency filter assembly according to claim 15, wherein said at least one distributed filter element is comprised of a first transmission line end face, separated from a second transmission line end face by a gap.
